(19) United States
(12) Patent Application Publication
(10) Pub. No.: US 2018/0121209 A1
(43) Pub. Date: May 3, 2018

(54) ADAPTIVE MECHANISMS TO IMPROVE BOOT PERFORMANCE

(71) Applicant: Microsoft Technology Licensing, LLC, Redmond, WA (US)

(72) Inventors: Vijay Sundaram, Kirkland, WA (US); Mehmet lyigun, Kirkland, WA (US); Yevgeniy M. Bak, Redmond, WA (US); Prashant Ratanchandani, Kirkland, WA (US)

(21) Appl. No.: 15/339,646

(22) Filed: Oct. 31, 2016

(51) Int. Cl. G06F 9/44; G06F 3/06; G06F 12/0862

(52) U.S. Cl. CPC G06F 9/4406; G06F 3/061; G06F 2212/602; G06F 3/0683; G06F 12/0862; G06F 3/0647

(57) ABSTRACT

A computing system includes a first memory that stores IO data, a second memory, and a boot manger. A pre-fetch manager pre-fetches IO data from the first memory to the second memory when the boot process is initiated. A detector component determines that an amount of the IO data pre-fetched by the pre-fetch manager has fallen behind a rate at which the pre-fetched IO data is executed by the computing system. An optimizer component causes the boot process to be paused to create a pause window and causes the pre-fetch manager to pre-fetch during the pause window a subset of the IO data. The subset has a magnitude that is determined to result in the amount of IO data pre-fetched by the pre-fetch manger substantially matching the rate at which the pre-fetched IO data is executed when the pause window is ended and the boot process is resumed.

### BACKGROUND

Boot of a computing device, especially on systems with rotational drives, is often Input/Output (IO) bound. Previous attempts to increase the efficiency of the boot process have included pre-fetching mechanisms that are based on a deadline schedule. Given the deadline constraints, the schedule is commonly revised to improve the IO throughput where possible.

A key limitation, however, to the pre-fetching mechanisms that are based on a deadline schedule is that such mechanism are often not aware if the pre-fetching falls behind a rate at which the system consumes the IO data that has been pre-fetched and thus cannot correct for being behind. This often leads to the pre-fetching mechanisms aborting the pre-fetching, which degrades the speed and efficiency of the boot process.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein are related to systems, methods, and computer readable medium for adaptively improving the efficiency of a boot process of a computing system. In one embodiment, a computing system includes a first memory that stores IO data, a second memory, and a boot manger that controls the boot process for the computing system. A pre-fetch manager of the computing system pre-fetches IO data from the first memory to the second memory when the boot process is initiated. A detector component determines that an amount of the IO data pre-fetched by the pre-fetch manager from the first memory to the second memory has fallen behind a rate at which the pre-fetched IO data is executed by the computing system. An optimizer component of the computing system causes the boot manager to pause the boot process to create a pause window. The optimizer component also causes the pre-fetch manager to pre-fetch during the pause window a subset of the IO data. The subset has a magnitude that is determined by the optimizer component to result in the amount of IO data pre-fetched by the pre-fetch manger substantially matching the rate at which the pre-fetched IO data is executed when the pause window is ended and the boot process is resumed.

In another embodiment, it is determined an amount of IO data pre-fetched by a pre-fetch manager has fallen behind a rate at which the pre-fetched IO data is executed by the computing system. A boot process is paused to create a pause window. The pre-fetch manager is caused to pre-fetch during the pause window a subset of the IO data. The subset has a magnitude that is determined by the optimizer component to result in the amount of IO data pre-fetched by the pre-fetch manger substantially matching the rate at which the pre-fetched IO data is executed when the pause window is ended and the boot process is resumed. The pause window is ended and the boot process resumes.

Additional features and advantages will be set forth in the description, which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates an embodiment of a computing system able to adaptively improve the efficiency of a boot process of a computing system;

FIGS. 3A-3D illustrate an time line of a boot process according to an embodiment disclosed herein;

FIG. 4 illustrates an embodiment of a table that specifies increment/decrement of a pre-fetch magnitude according to an embodiment disclosed herein;

FIG. 5 illustrates an alternative embodiment of a time line of a boot process;

FIG. 6 illustrates a further embodiment of a time line of a boot process;

FIG. 7 illustrates a flow chart of an example method for adaptively improving the efficiency of a boot process of a computing system.

### DETAILED DESCRIPTION

Aspects of the disclosed embodiments relate to systems, methods, and computer readable medium for adaptively improving the efficiency of a boot process of a computing system. In one embodiment, a computing system includes a first memory that stores Input/Output (IO) data, a second memory, and a boot manger that controls the boot process for the computing system. A pre-fetch manager of the computing system pre-fetches IO data from the first memory to the second memory when the boot process is initiated. A detector component determines that an amount of the IO data pre-fetched by the pre-fetch manager from the first memory to the second memory has fallen behind a rate at which the pre-fetched IO data is executed by the computing system. An optimizer component of the computing system causes the boot manager to pause the boot process to create a pause window. The optimizer component also causes the pre-fetch manager to pre-fetch during the pause window a subset of the IO data. The subset has a magnitude that is determined by the optimizer component to result in the amount of IO data pre-fetched by the pre-fetch manger substantially matching the rate at which the pre-fetched IO data is executed when the pause window is ended and the boot process is resumed.

There are various technical effects and benefits that can be achieved by implementing aspects of the disclosed embodiments. By way of example, it is now possible to adaptively improve the efficiency of a boot process by pausing the boot process and letting the pre-fetch manager pre-fetch enough IO data from the hard disk so that the pre-fetch manager is not likely to fall behind. In addition, it is now possible to determine the magnitude of pre-fetched IO data that will help ensure the pre-fetch manger does not fall behind. Further, the technical effects related to the disclosed embodiments can also include improved user convenience and efficiency gains.

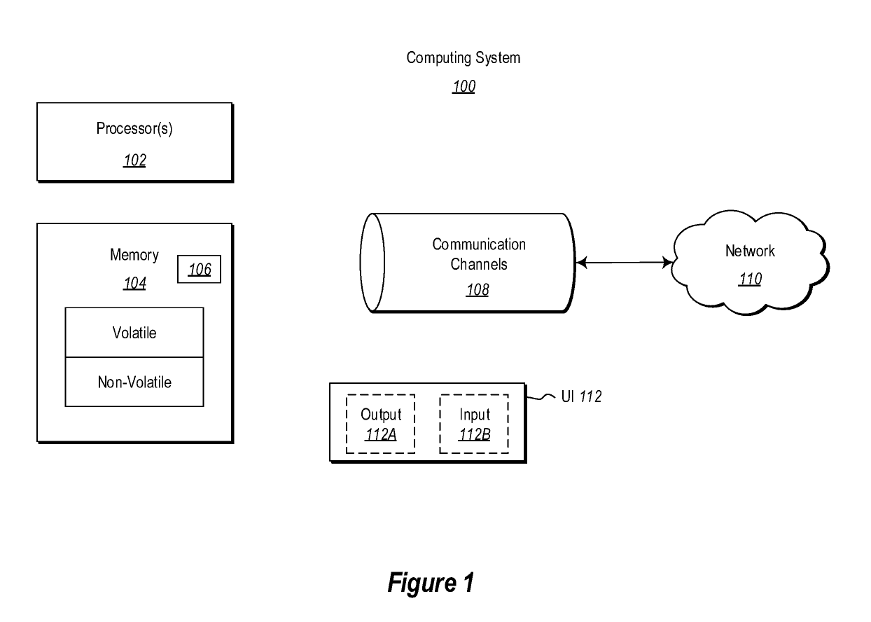

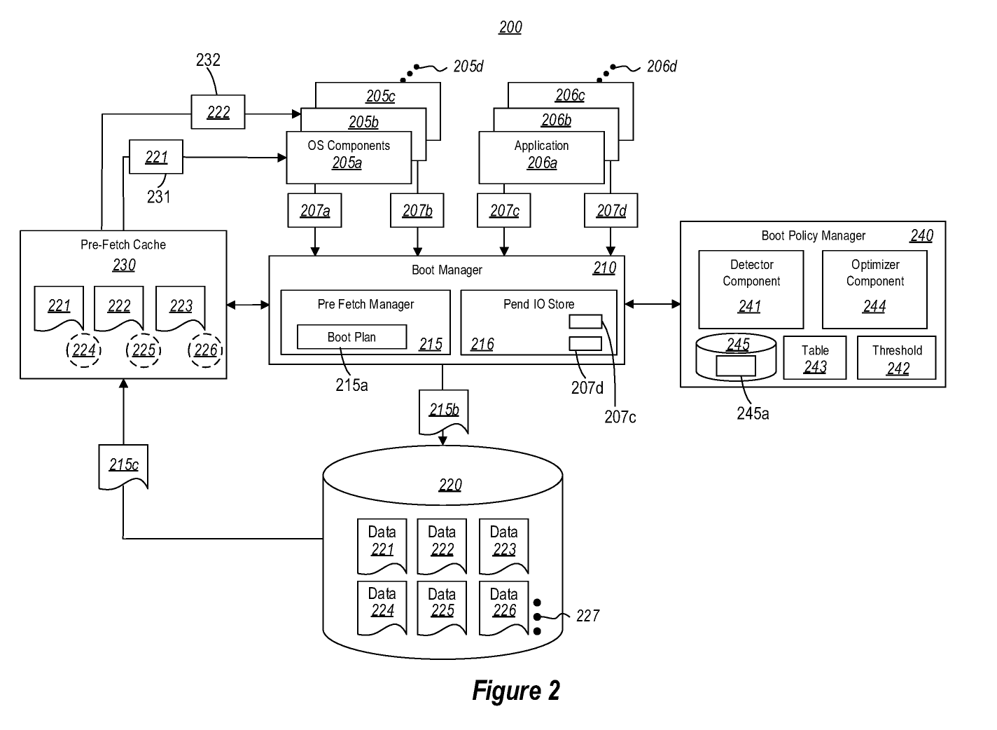

Some introductory discussion of a computing system will be described with respect to FIG. 1. Then, the system for adaptively improving the efficiency of a boot process will be described with respect to FIG. 2 through FIG. 7.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Attention is now given to FIG. 2, which illustrates an embodiment of a computing system 200, which may correspond to the computing system 100 previously described. The computing system 200 includes various components or functional blocks that may implement the various embodiments disclosed herein as will be explained. The various components or functional blocks of computing system 200 may be implemented on a local computing system or may be implemented on a distributed computing system that includes elements resident in the cloud or that implement aspects of cloud computing. The various components or functional blocks of the computing system 200 may be implemented as software, hardware, or a combination of software and hardware. The computing system 200 may include more or less than the components illustrated in FIG. 2 and some of the components may be combined as circumstances warrant. Although not necessarily illustrated, the various components of the computing system 200 may access and/or utilize a processor and memory, such as processor 102 and memory 104, as needed to perform their various functions.

As illustrated in FIG. 2, the system 200 includes a boot manager 210. In operation, the boot manager 210 controls or manages a boot process or sequence that occurs when the system 200 is first turned on. Accordingly, the boot manager 210 conceptually represents the computing system 200 elements, logic and other tools that control the boot process when it is performed.

During a boot process or sequence, the boot manager 210 may receive various IO requests from various operating system components and/or applications for IO data that is stored on a hard disk 220 of the computing system 200. For example, as shown in FIG. 2 the hard disk 220 may include IO data 221-226, with the ellipses 227 representing that the hard disk 220 may include any number of additional IO data. The IO requests will typically be a read request for the IO data during a boot process; however the IO requests may also be write requests or any other IO request as circumstances warrant. The IO data may then be used by the various operating system components and/or applications during the boot process. This process will be described in more specific detail to follow.

For example, the computing system 200 may include one or more Operating System (OS) components 205a, 205b, 205c, or any other number of OS components as illustrated by ellipses 205d (hereinafter also referred to collectively as “OS components 205”). In addition, the computing system may include one or more applications 206a, 206b, 206c, and any number of additional applications as illustrated by the ellipses 206d (hereinafter also referred to collectively as “applications 206).

In some embodiments, the boot manager 200 includes or is otherwise associated with a pre-fetch manager 215. During the boot process, the pre-fetch manager 215 is able to pre-fetch at least some of the IO data 221-226 from the disk 220 ahead of when such IO data is needed by one or more of the OS components 205 and/or applications 206. The pre-fetch manager 215 may store the pre-fetched IO data in a pre-fetch cache 230, which may be RAM or may be part of the hard disk 220, where the pre-fetched IO data is available for execution or consumption by the one or more of the OS components 205 and/or applications 206. Since the one or more of the OS components 205 and/or applications 206 do not need to wait for the IO data to be fetched from the disk 220, the pre-fetching performed by the pre-fetch manager 215 may speed up the boot process.

In order to pre-fetch the right IO data at the right time during the boot process, the pre-fetch manager 215 may build a boot plan 215a that is based on past boot processes. That is, the pre-fetch manager detects the IO data that is used or consumed by the one or more of the OS components 205 and/or applications 206 during the past boot processes. The pre-fetch manager may then use this knowledge of the IO data used previously when building the boot plan. In this way, the pre-fetch manager 215 is able to know which IO data to pre-fetch during subsequent boot processes and is also able to know the time period that such IO data should be pre-fetched. In some embodiments, the pre-fetch manager 215 may optimize the location of the IO data stored on the disk 220 so that the IO data that is to be pre-fetched will be located close to each other, thus speeding up the pre-fetch process.

A specific example of the pre-fetch process will now be described. Upon initiation of a boot process, the pre-fetch manager 220 will begin to pre-fetch the IO data from the hard disk 220 according to the boot plan 215a. For example, suppose that the boot plan 215a specified that the IO data 221-226 should be pre-fetched during the boot process. The pre-fetch manager 215 would then begin to pre-fetch the IO data from the hard disk 220 as represented by element 215b. Although not shown for ease of illustration, the pre-fetch manager would utilize various computing system 200 components such as an IO manager, volume manager, and the like while pre-fetching the IO data. As illustrated, the IO data 221, 222, and 223 are pre-fetched to the pre-fetch cache 230 at the time period illustrated in FIG. 2. The dashed lines represent that IO data 224-226 has yet to be pre-fetched at the time period illustrated in FIG. 2, although as mentioned previously this data is scheduled to be pre-fetched according to the boot plan 215a within a certain period during the boot process.

During the boot process, the OS components 205 and/or the applications 206 may begin to issue IO requests for the IO data 221-226. For example, the OS component 205a may issue an IO request 207a for the IO data 221 and the OS component 205b may issue an IO request 207b for the IO data 222. Since the IO data 221 and 222 has been pre-fetched to the pre-fetch cache 230 at the time of the IO requests 207a and 207b, both of these IO requests may be serviced by pre-fetch cache 230 and the IO data 221 and 222 may be used or executed by the OS component 205a and 205b as denoted at 231 and 232 respectively. This is sometimes referred to as a “hit” since the IO data requested by the IO requests has been pre-fetched to the pre-fetch cache 230 at the time of the IO requests.

During the boot process, the application 206a may issue an IO request 207c for the IO data 224 and the application 206b may issue an IO request 207d for the IO data 225. As mentioned previously, the IO data 224 and 225 are scheduled to be pre-fetched within a certain period but have yet to be pre-fetched by the pre-fetch manager 215. An IO request for IO data that is scheduled to be pre-fetched but has yet to been pre-fetched may be referred to as a “pend IO”. In such circumstances, the boot manager 210 blocks the IO requests 207c and 207d and places the requests in a pend IO store 216 since they may now be considered pend IOs. That is, the boot manager 210 is willing to pause the execution of the pend IOs 207c and 207d for a short time because it knows that the IO data 224 and 225 is scheduled by the boot plan 215a to be shortly pre-fetched and thus any delay in the boot process is offset by the efficiency of waiting for the scheduled IO data to be pre-fetched. When the IO data 224 and 225 is finally pre-fetched by the pre-fetch manager 215, the IO requests 207c and 207d may be released from the pend store 216 and the requests may be serviced by the pre-fetch cache 230. The applications 206a and 206b are then able to use or execute the IO data 224 and 225 respectively.

In some embodiments, however, the boot manager 210 may not include the pend store 216 and thus in such embodiments no pend IOs are held. In such embodiments, those IO requests where the IO data has been pre-fetched will be serviced by the pre-fetch cache 230 in the manner described while those IO requests that have not been pre-fetched will hit the hard disk 220.

As may be appreciated, it would advantageous to the computing system 200 if the pre-fetch manager 215 was always able to pre-fetch the IO data from the disk 220 at the same rate (or close to the same rate) that the pre-fetched data was used or executed by the OS components 205 and/or applications 206. In this way, there would likely be little delay in the boot process while the OS components 205 and/or applications 206 waited for the IO data to be pre-fetched prior to using or executing the data.

However, in some embodiments the pre-fetch manager 215 may fall behind as it is pre-fetching the IO data from the hard disk 220. In other words, the amount of the IO data 221-226 that is pre-fetched by the pre-fetch manager 215 is not able to keep up with the rate that the processor associated with the OS components 205 and/or applications 206 is able to use or execute the IO data. Said another way, the pre-fetch manager 215 is considered to have fallen behind when the rate of pre-fetching is slower than the rate that the pre-fetched IO data is consumed by the OS components 205 and/or applications 206. The falling behind may be caused by an unbalanced system where processing resources are faster than the speed the hard disk can retrieve the IO data or it may be caused when the boot plan becomes so large so that the pre-fetch manager is simply unable to keep up with all the IO data scheduled to be pre-fetched. There may also be other reasons the pre-fetch manager falls behind.

In some embodiments, IO requests for IO data that is not pre-fetched and that is not scheduled in the boot plan to be pre-fetched may be sent directly from one or more of the OS components 205 and/or applications 206 to the hard disk 220. These may be referred to as a “miss”. A large number of miss IO requests hitting the hard disk 220 may be part of the reason that the pre-fetch manger falls behind.

Having the pre-fetch manager 215 fall behind may have adverse effects on the boot process. For example, the pre-fetch manager 215 may choose to abort further pre-fetching since the delay to the boot process outweighs any benefit provided by the pre-fetching. In those embodiments where the pend IOs are held in the pend IO store 216, a large pend IO count will build up in the pend IO store when the pre-fetch manager 215 falls behind and the pre-fetch manager may determine it is behind by detecting the large pend IO count in the pend IO store 216. Once aborted, any further benefit from pre-fetching is lost. Even in those cases where the pre-fetch manager does not abort the pre-fetching process, having it fall behind may slow down the boot process as there are delays in servicing the IO requests.

Advantageously, the embodiments disclosed herein include systems and mechanisms that are configured to adaptively improve the efficiency of the boot process to thereby increase the likelihood that the pre-fetch manager 215 will pre-fetch the IO data at or close to a rate at which the OS components 205 and/or applications 206 are able to use or execute the pre-fetched IO data. In this way, the likelihood that the pre-fetch manger will fall behind is decreased.

Accordingly, the computing system 200 may include a boot policy manager 240. Although shown as being separate from the boot manager 210, in some embodiments the boot policy manager 240 may be part of the boot manager 210. The boot policy manager 240 may include a detector component 241. In operation, the detector component 241 is able to detect that the pre-fetch manager 215 has fallen behind. That is, the detector component 241 determines some measurable indicator that the amount of IO data that is pre-fetched by the pre-fetch manager has fallen behind the rate at which that data is consumed by the OS components 205 and/or the applications 206. In some embodiments, the detection is based on a predetermined threshold 242 and a table 243 that specifies changes to a pause window as will be described in more detail to follow.

For example, in the embodiment including the pend IO store 216, the detector component 241 may measure or detect the pend IO count of the pend IOs stored in the pend IO store 216 as the measureable indicator that the pre-fetch manager has fallen behind. In such embodiments, the detector component 241 measures the pend IO count for a given amount of time and then compares the measured IO count with the predetermined threshold 242. If the measured pend IO count is below the predetermined threshold 242, it may be inferred that the pre-fetch manager has not fallen behind or has only fallen behind an acceptable amount. That is, in some embodiments the pre-fetch manager 215 may fall behind at a small rate that is acceptable to the boot process and thus does not warrant system resources to correct as will be described in more detail to follow and the predetermined threshold 242 may be set at a value that reflects this. If, however, the measured pend IO count is above the threshold, then it may be inferred that the pre-fetch manager has fallen behind.

As mentioned above, some embodiments do not include the pend IO store 216 and the computing system 200 does not hold any pend IOs. In such embodiments, the detector component 241 may use other measureable indicators that the pre-fetch manager has fallen behind. For example, in one embodiment the detector component may measure the amount of IO requests that hit the hard disk 220. Since it is known from the boot plan 215a the IO data that is scheduled to be pre-fetched, a large number of IO requests hitting the hard disk may show the pre-fetch manager 215 is behind as those IO requests not yet pre-fetched may be sent directly to the hard disk 220. In addition, as discussed above, a large number of “miss” IO requests may also indicate the pre-fetch manager 215 has fallen behind. In some embodiments, the threshold 242 may specify what number of IO requests hitting the hard disk 220 would be indicative of the pre-fetch manager falling behind.

In still other embodiments, the detector component 241 may measure the amount of time that the pre-fetch manager 215 performs pre-fetching of the IO data. If the detector component 241 measures an amount of time that the pre-fetch manager 215 performs pre-fetching that exceeds an expected amount of time that the pre-fetch manager 215 should pre-fetch the IO data (i.e., a known amount of time for when pre-fetching should be completed), it may be inferred that the pre-fetch manager has fallen behind. In such embodiments the threshold 242 may specify the expected amount of time that the pre-fetching should occur in.

In still further embodiments, the detector component 241 may measure the size (i.e. total amount of megabytes) of the IO data in the pre-fetch store 230 that has been pre-fetched by the pre-fetch manager 215. If the detector component 241 measures that the size of the pre-fetched IO data is less than an expected amount, it may be inferred that the pre-fetch manager has fallen behind. In such embodiments the threshold 242 may specify the expected size of the IO data that should be pre-fetched.

As may be appreciated, the boot process typically occurs in a sequential manner for the various subsystems of the computing system 200. For example, when the boot process is initiated a first subsystem such as the power subsystem turns on. This is followed by a second subsystem such as a disk subsystem turning on and then a third subsystem such as various drivers being turned on. It will be appreciated that the sequence of the boot process may be in any order as circumstances warrant. When each of the subsystems is turned on it may be considered a boot marker.

In some embodiments, the detector component 241 may measure the size of the IO data in the pre-fetch cache or the number of pend IOs at each of the boot markers in the boot process. The detector component 241 may then determine if the pre-fetch manager 215 is behind at any of the boot markers.

The detector component 241 may also detect if the pre-fetch manager 215 has aborted the pre-fetch operation. It will be appreciated that an abort would indicate that the pre-fetch operation has fallen behind for the reasons previously described. It will also be appreciated that the detector component 241 may use any reasonable measureable indicator that the pre-fetch manager has fallen behind. Accordingly, the embodiments disclosed herein are not limited by any specific measurable indicator used by the detector component 241 to determine that the pre-fetch manager has fallen behind.

The boot policy manger 240 may also include an optimizer component 244. In operation, the optimizer component 244, once it has been detected by the detector component 241 that the pre-fetch manager 215 has fallen behind, is able to cause the boot manger 220 to pause the boot process. While the boot process is paused, a pause window may be generated where very little of the pre-fetched IO data already in the pre-fetch cache 230 is executed. During this pause window, the optimizer component 244 causes the pre-fetch manager 215 to pre-fetch a subset of the IO 221-226 data from hard disk 220. The subset of IO data may be specified by the boot plan 215a or it may be determined in other ways.

The purpose of pre-fetching during the pause window is to allow the pre-fetch manager 215 to pre-fetch an amount of IO data in an efficient manner that will likely ensure that the pre-fetch manager 215 is no longer behind (or never gets behind) when the pause window ends and the boot process is resumed. Said another way, pre-fetching during the pause window gives the pre-fetch manager 215 a head start in pre-fetching the IO data to the pre-fetch store 230 so that when the pause window ends and the OS components 205 and/or the applications 206 begin to use or execute the IO data, enough of the IO data is already in the cache 230 that there is little or no delay in the execution of the IO data. In some embodiments, the IO data pre-fetched during the pause window may be pre-fetched in disk offset order to ensure an efficient pre-fetching of the IO data. In other embodiments, the IO data pre-fetched during the pause window may be pre-fetched in other ways as well.

As may be appreciated, because the boot process is paused during the pause window, the amount or magnitude of the IO data 221-226 that is pre-fetched should be as optimal as possible. For example, if the amount or magnitude of the IO data that is pre-fetched during the pause window is too little, then the pre-fetch manager 215 may remain behind when pause window is closed. However, if the amount or magnitude of the IO data that is pre-fetched during the pause window is too large, then the boot process may be unnecessarily lengthened. Accordingly, the optimizer component 244 is configured to adaptively determine the optimal amount or magnitude (or close to the optimal amount or magnitude) of the IO data that is be pre-fetched during the pause window and also the length of the pause window.

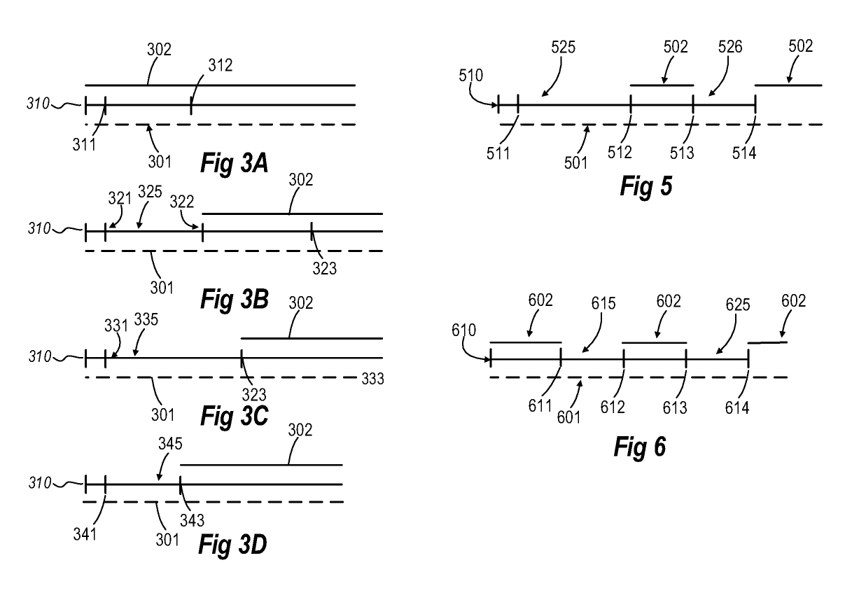

A specific example embodiment of the detection process of the detector component 241 and the optimizer component 244 will now be described in relation to FIGS. 3A-3D. The embodiment of FIGS. 3A-3D is adaptively performed over a number of successive boot processes and thus does not necessarily happen in real time.

FIG. 3A shows a time line of a first boot process. At a point 310, the computing system 200 is turned on and the first boot process is initiated. At this time, the pre-fetch manager 215 will begin to pre-fetch one or more of the IO data 221-226 to the pre-fetch cache 230 according to the boot plan 215a as represented in the figure by the dashed line 301. In addition, at this time one or more of the OS components 205 and/or the applications 206 will begin to use or execute the IO data in the pre-fetch cache 230 as represented by the solid line 302.

At point 311, which is near to the point the boot process is initiated, the detector component 241 may begin to measure the pend IO count in the pend IO store 216. This measurement may occur until the point 312. Although this example is using pend IO count as the measurable indicator that the amount of IO data that is pre-fetched by the pre-fetch manager 215 has fallen behind the rate at which that data is consumed by the OS components 205 and/or the applications 206, it will be appreciated that any of the measurable indicators previously discussed may also be used. Thus use of pend IO count is for illustrative purposes only and is not limiting on the embodiments disclosed herein.

The detector 241 may then compare the measure pend IO count with the threshold 242 and log at 245a the results in a memory 245 that is associated with the boot policy manager 240. For example, in one embodiment the threshold pend IO count may be 128 megabytes. Accordingly, if the pend IO count is less than 128 megabytes, then detector component 241 logs in the memory 245 that the pend IO count is below the threshold and no action is taken on subsequent boot processes. However, if the pend IO count is above 128 megabytes, then this is logged in the memory 245 as indicating that it is likely that the pre-fetch manager 215 has fallen behind as previously discussed.

In some embodiments, at least two boot processes should have a pend IO count that is above the threshold value before any action is taken on subsequent boot processes. This helps to ensure that a high pend IO count for any given boot process is not the result of an anomaly that does not occur in other boot processes. In addition, in some embodiments, an effective pend IO count is determined by upper bounding the count and exponentially smoothing the count in order to balance recent pend IO counts with historical pend IO counts. The effective pend IO count may then be compared with the threshold 242.

FIG. 3B shows a timeline for a second boot process that is subsequent to the first boot process shown in FIG. 3A. For purposes of illustration, it is assumed that the second boot process occurs after at least two prior boot processes having pend IO counts that exceed the threshold value 242 have been logged by the detector component 241 in the memory 245. As in FIG. 3A, at the point 310, the computing system 200 is turned on and the second boot process is initiated. At this time, the pre-fetch manager 215 will begin to pre-fetch one or more of the IO data 221-226 to the pre-fetch cache 230 according to the boot plan 215a as represented in the figure by the dashed line 301.

Since the detector component 241 had previously logged at 245a in the memory 245 that the pend IO from the previous boot processes were over the threshold, the optimizer component 244 may infer that the pre-fetch manager 241 will fall behind in this boot process. Accordingly, at point 321 the optimizer component 244 may cause the boot manager 210 to pause the boot process, specifically the execution of the IO data in the pre-fetch cache 230, thereby creating a pause window 325. As shown in the figure, the boot process is paused near to the point of boot initiation. This may advantageously help ensure that the IO data pre-fetched while the boot process is paused will be available for the remainder of the boot process. However, in some embodiments the boot process may be paused further into the boot process in circumstances where this is warranted.

The optimizer component 244 may then direct the pre-fetch manager 215 to pre-fetch a subset of the IO data 221-226 while the boot process is paused. For example, in the embodiment where the pend IO count threshold is 128 megabytes, the optimizer component 244 may set the subset of the IO data at 128 megabytes. In other words, 128 megabytes of the IO data will be pre-fetched during the pause window 325. As previously discussed, the IO data may be pre-fetched in disk offset order, although this not required. Accordingly, the pause window may be considered to have a period of 128 megabytes. In some embodiments, the duration of the pause window 325 may be upper-bounded by the optimizer component 244. Accordingly, if desired magnitude of the pre-fetching is not completed within the allotted duration, the pause window is closed. In the way, the optimizer component prevents keeping the pause window open for a duration that will take away from the benefits provided by the pause window as the boot process is extended for too long a time.

In other embodiments the optimizer component 244 may set the period of the pause window 325 on the basis of an amount of time needed to pre-fetch the specified IO data or use some other way to determine the period of the window 325. For example, in embodiments were the detector module 241 determines if the pre-fetch module 215 is behind based on the amount of time that the pre-fetching should be completed, the pause window may be set based on time.

At point 322, the pre-fetch manager 215 has pre-fetched the 128 megabytes of IO data and the optimizer component 244 causes the boot manager 210 to end the pause window 325 and to allow boot process to move forward. Accordingly, as represented by the solid line 302, one or more of the OS components 205 and/or the applications 206 are able to use or execute the IO data in the pre-fetch cache 230. The IO data that begins to be executed at the point 322 is primarily the IO data pre-fetched during the pause window 325. The pre-fetch manager 215 will also continue to pre-fetch the IO data according to the boot plan 215a after the point 322. Since the pre-fetch manager 214 has been given the 128 megabyte head start in pre-fetching the IO data, if enough IO data has been pre-fetched then the pre-fetch manager 215 should not fall behind during the remainder of the boot process.

At the point 322, the detector component 241 may begin to measure the pend IO count (if any) that appears for a given amount of time after the close of the pause window 325. In one embodiment, this time period, which is between points 322 and 323, may be the first 30 seconds after the close of the pause window, although any other reasonable amount of time may be used. Any pend IO count that is measured is then logged at 245a in the memory 245.

FIG. 3C shows a timeline for a third boot process that is subsequent to the second boot process shown in FIG. 3B. As previously described, at the point 310, the computing system 200 is turned on and the third boot process is initiated. At this time, the pre-fetch manager 215 will begin to pre-fetch one or more of the IO data 221-226 to the pre-fetch cache 230 according to the boot plan 215a as represented in the figure by the dashed line 301.

During this boot process, the optimizer component 244 may access the pend IO count from the 30 second window logged at 245a by the detector component 241 in the last boot process. The optimizer component 244 may then use this pend IO count to determine if the IO data pre-fetched in the pause window 325 was of proper magnitude to prevent the pre-fetch manager 215 from falling behind or if the magnitude and pause window need to be increased or decreased. As previously described, if the pre-fetching in the pause window is too little, the pre-fetcher may still be behind and if the pre-fetching is too much, the boot process in unnecessarily delayed.

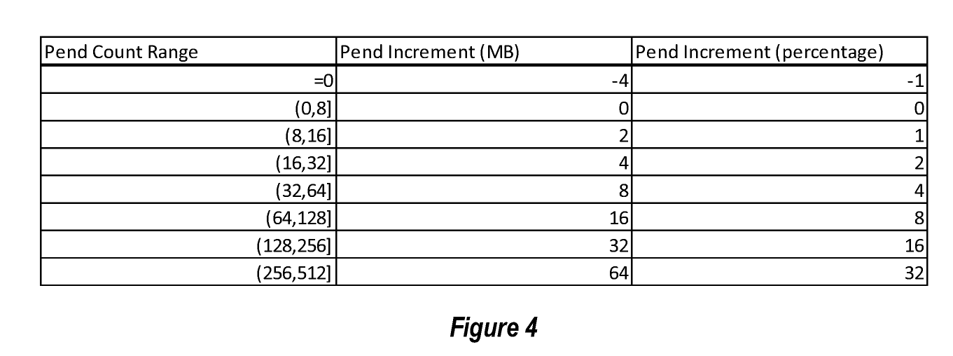

In one embodiment, the optimizer component 244 may read a table 243 that specifies an increment/decrement for the magnitude of the pre-fetch in the pause window based on the pend IO count from the 30 second window. An example of such table is shown in FIG. 4. As illustrated, the table in FIG. 4 shows various increments in megabytes that should be added to or subtracted from the pre-fetch during the pause window based on a range of pend IO counts. For example, if the pend IO count is 0, then the magnitude should be decreased by 4 megabytes so as to correct for any excess pre-fetching. If the pend IO count is in one of the ranges that is greater than 8, thus indicating that the magnitude of the pre-fetch was not enough, then the magnitude of the pre-fetch in the pause window should be increased by the relevant amount shown in the table. However, if the pend IO count is in the range that is greater than 0 but less than 8, then the magnitude of the pre-fetch is kept unchanged as this is considered to likely ensure that the pre-fetch manager 215 does not fall behind (or only falls behind an acceptable amount) during the remaining boot process without extending the pause window unnecessarily. In some embodiments, the table 243 may also specify an increment/decrement for the magnitude of the pre-fetch in the pause window based on a percentage of the IO data in the boot plan 215a as also shown in FIG. 4 to ensure a certain magnitude for the pause window in embodiments where operational circumstances have rendered the listed ranges obsolete or otherwise unusable.

The optimizer component 244 may then pause the boot process at point 331 and set pause window 335 in which the pre-fetch manager 215 is caused to pre-fetch the specified amount of IO data 221-226. Suppose for example that the detector component 241 detected a large pend IO count in the 30 second window of the last boot process. The optimizer component 244 may then use the table 243 or may use some other way to determine that the pause window 335 and the amount of IO data pre-fetched during the pause window will need to be increased from the second boot process. This is shown in FIG. 3C, where the pause window 335 is larger than the pause window 325 of FIG. 3B.

At point 332, the pre-fetch manager 215 has pre-fetched the specified megabytes of IO data, which is increased from the 128 megabytes pre-fetched in previous boot process, and the optimizer component 244 causes the boot manager 210 to end the pause window 335 and to allow boot process to move forward. Accordingly, as represented by the solid line 302, one or more of the OS components 205 and/or the applications 206 are able to use or execute the IO data in the pre-fetch cache 230. At the point 332, the detector component 241 may begin to measure the pend IO count (if any) that appear in the window between 332 and 333. Any pend IO count that is measured is then logged at 245a in the memory 245.

FIG. 3D illustrates a fourth boot process, which will only be briefly described. In this boot process it is shown that the optimizer component 244 has set a pause window 345 between points 341 and 343 that is smaller than the pause window 335 of FIG. 3C. This illustrates that if the pend IO count in the 30 second window in the third boot process is small, the pause window and magnitude of the IO data pre-fetched in the pause window 345 will be decreased. The process described above may be repeated as many times a needed for each subsequent boot process after the illustrated fourth boot process until such time as the optimizer component 244 converges to a magnitude for the IO data pre-fetched during the pause window that is likely to match the rate the pre-fetched IO data is used or executed by the OS components 205 and/or the applications 206.

Although in the above example the optimizer component 244 was described as using the pend IO count from a previous boot process and the table 243 to determine the period of the pause window and the magnitude of the IO data to pre-fetch in the pause window, this was for illustrative purposes only. It will be appreciated that the optimizer component 244 may use any reasonable means to determine a magnitude for the IO data pre-fetched during the pause window that is likely to match the rate the pre-fetched IO data is used or executed by the OS components 205 and/or the applications 206.

For example, in the embodiment described above that uses boot markers, the optimizer 244 may weight the pend IO counts seen at each boot marker. For instance, the pend IO count seen at the first boot marker may be given a 100% weighting as the IO data at the first boot marker may be critical IO data that needs to be pre-fetched as efficiently as possible. At the second boot marker, the IO pend count may be given a 50% weighting as this IO data to be pre-fetched at this point may be less important than at the first boot marker. In like manner, the IO pend count at the third and subsequent boot markers may be given a smaller weighting since the IO data become less critical. The optimizer component 244 may then use these various weights when determining the length of the pause window. That is, the optimizer component 244 may set the length of the pause window so that that all the IO data at the first boot marker, at least 50% of the IO data at the second marker and so forth are pre-fetched during the pause window. Such pause window should then help to ensure that the pre-fetch manager 215 does not fall behind at any of the boot markers.

Other reasonable means may include using an IO request count for each boot process or using the total expected time for pre-fetching to occur. Thus, the embodiments disclosed herein are not limited to any specific way the optimizer component 244 determines a magnitude for the IO data pre-fetched during the pause window.

FIG. 5 illustrates a time line of an alternative embodiment of a boot process. At the point 510, the computing system 200 is turned on and the boot process is initiated. At this time, the pre-fetch manager 215 will begin to pre-fetch one or more of the IO data 221-226 to the pre-fetch cache 230 according to the boot plan 215a as represented in the figure by the dashed line 501.

At the point 511, which may be near to the point the boot process is initiated, although this is not required, the optimizer component 244 may cause the boot manager 210 to pause the boot process, thereby creating a pause window 525. As in the embodiments previously described, the optimizer component 244 may cause the pre-fetch manager 215 to pre-fetch a subset of the IO data 221-226 while the boot process is paused.

At point 512, the pre-fetch manager 215 has pre-fetched the subset of the IO data 221-226 and the optimizer component 244 causes the boot manager 210 to end the pause window 525 and to allow boot process to move forward. Accordingly, as represented by the solid line 502, one or more of the OS components 205 and/or the applications 206 are able to use or execute the IO data in the pre-fetch cache 230.

At a point 513, the optimizer component 244 may cause the boot manager 210 to again pause the boot process, thereby creating a second pause window 526. As with the pause window 525, the optimizer component 244 may cause the pre-fetch manager 215 to pre-fetch a subset of the IO data 221-226 while the boot process is paused. At point 514, the pre-fetch manager 215 has pre-fetched the subset of the IO data 221-226 and the optimizer component 244 causes the boot manager 210 to end the pause window 526 and to allow boot process to move forward.

FIG. 5 illustrates that in some embodiments the optimizer component may set more than one pause window during a boot process. For example, the optimizer component 244 may determine that 128 megabytes of the IO data 221-226 should be pre-fetched during a pause window to achieve the benefits previously discussed. However, in some embodiments it may be more efficient to pre-fetch 100 megabytes of the IO data during the first pause window 525 and the remaining 28 megabytes during the second pause window 526. In some embodiments, there may be any number of additional pause windows as circumstance warrant. Accordingly, the embodiments disclosed herein are not limited to any particular number of pause windows.

In the previously described embodiments, the detector component 241 and the optimizer component 244 were described as operating in non-real time since any change to the magnitude of the IO data pre-fetched during a pause window occurred on the next boot process. However, this need not be the case as there are embodiments where the detector component 241 and the optimizer component 244 are able to operate in real time. For example, FIG. 6 illustrates a time line of a boot process where the detector component 241 and the optimizer component 244 operate in real time.

As illustrated, at point the point 610, the computing system 200 is turned on and the boot process is initiated. At this time, the pre-fetch manager 215 will begin to pre-fetch one or more of the IO data 221-226 to the pre-fetch cache 230 according to the boot plan 215a as represented in the figure by the dashed line 501. In addition, one or more of the OS components 205 and/or the applications 206 will begin to use or execute the pre-fetched data as illustrated by the solid line 602.

At the point 610 the detector component 241 may begin to detect whether the pre-fetch manager 215 has fallen behind. The detector component 241 may make this detection using any of the measurable indicators discussed previously. In the embodiment, at point 611 the detector component may detect that the pre-fetch manager 215 has fallen behind.

The optimizer component 244 may then determine in any manner previously discussed a magnitude of the IO data that should be pre-fetched during a pause window so that the pre-fetch manager 215 will no longer be behind. The optimizer component 244 may cause the boot manager 220 to pause the boot process to thereby create the pause window 615. At the point 612 the pre-fetching is completed and the boot process is allowed to resume.

At the point 612 the detector component 241 may again begin to detect whether the pre-fetch manager 215 has fallen behind. In the embodiment, at point 613 the detector component may detect that the pre-fetch manager 215 has again fallen behind.

The optimizer component 244 may again determine a magnitude of the IO data that should be pre-fetched during a second pause window so that the pre-fetch manager 215 will no longer be behind. The optimizer component 244 may cause the boot manager 220 to pause the boot process to thereby create the second pause window 625. At the point 614 the pre-fetching is completed and the boot process is allowed to resume. This real time operation may be repeated as needed until the system reaches a point that the pre-fetch manager 215 is no longer behind.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

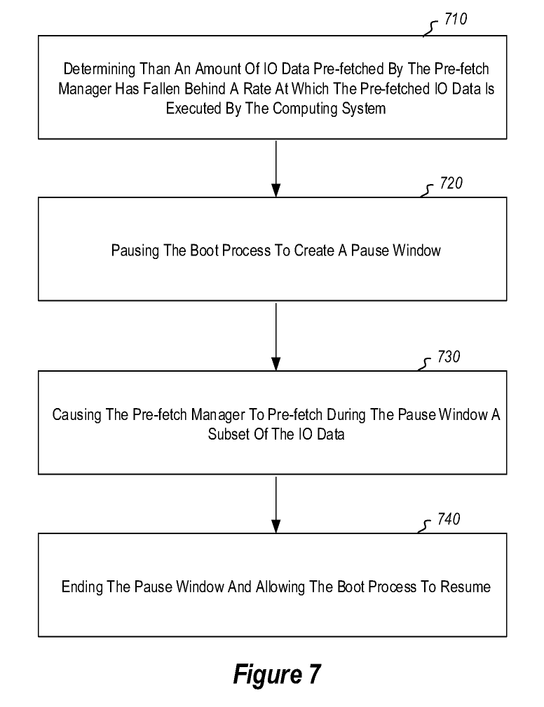

FIG. 7 illustrates a flow chart of an example method for adaptively improving the efficiency of the boot process to thereby increase the likelihood that a pre-fetch manager will pre-fetch IO data at or close to a rate at which the computing system is able to execute the pre-fetched IO data. The method 700 will be described in relation to one or more of FIGS. 2-6 previously discussed.

The method 700 includes an act of determining that an amount of IO data pre-fetched by the pre-fetch manager has fallen behind a rate at which the pre-fetched IO data is executed by the computing system (act 710). For example, as previously described, the pre-fetch manager 215 pre-fetches one or more of the IO data 221-226 from the hard disk 220 to the pre-fetch cache 230 according to a boot plan 215a. The detector component 241 is able to determine that the pre-fetch manager has fallen behind in any of the ways previously discussed.

The method 700 includes an act of pausing the boot process to create a pause window (act 720). For example, as previously discussed the optimizer component may direct or cause the boot manager 210 to pause the boot process. This will create a pause window such as pause window 325, 335, and 345.

The method 700 includes an act of causing the pre-fetch manager to pre-fetch during the pause window a subset of the IO data (act 730). The subset should have a magnitude that is determined to be likely to result in the amount of IO data pre-fetched by the pre-fetch manger to substantially match the rate at which the computing system is able to execute the pre-fetched IO data when the pause window is ended. For example, as previously described the optimizer component 244 may cause the pre-fetch manager 215 to pre-fetch some of the IO data 221-226 during the pause window. The IO data may be pre-fetched in disk offset order for efficiency. The IO data to pre-fetch may be identified in boot plan 215a.

As also previously described the optimizer component 244 may determine a magnitude for the IO data that is to be pre-fetched during the pause window and/or the length of the pause window. The magnitude of the IO data that is to be pre-fetched during the pause window is a magnitude that is likely to match the rate at which the pre-fetched data is consumed, which should prevent the pre-fetch manager from falling behind during the remainder of the boot process.

The method 700 includes an act of ending the pause window and allowing the boot process to resume (act 740). For example, as previously described the optimizer component 244 may cause the boot manager 210 to resume the boot process.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for adaptively improving the efficiency of a boot process of the computing system, the computing system comprising:
a first memory that stores Input/Output (IO) data;
a second memory;
a boot manager that is configured to control a boot process for the computing system;
a pre-fetch manager that is configured to pre-fetch one or more of the IO data from the first memory to the second memory upon initiation of the boot process;
a detector component that is configured to determine that an amount of the IO data pre-fetched by the pre-fetch manager from the first memory to the second memory has fallen behind a rate at which the pre-fetched IO data is executed by the computing system; and
an optimizer component that is configured to cause the boot manager to pause the boot process to thereby create a pause window, the optimizer component further configured to cause the pre-fetch manager to pre-fetch during the pause window a subset of the IO data, the subset having a magnitude that is determined by the optimizer component to be likely to result in the amount of IO data pre-fetched by the pre-fetch manger to substantially match the rate at which the pre-fetched IO data is executed when the pause window is ended and the boot process is resumed.

2. The computing system of claim 1, wherein during the pause window substantially none of the pre-fetched IO data is executed.

3. The computing system of claim 1, wherein the detector component is configured to determine that the pre-fetch manager has fallen behind the rate at which the pre-fetched IO data is executed by performing the following:
measure a pend IO count; and
compare the measured pend IO count with a threshold value, wherein when the measured pend count is higher than the threshold values it is indicative that the pre-fetch manager has fallen behind the rate at which the pre-fetched IO data is executed.

4. The computing system of claim 1, wherein the detector component is configured to determine that the pre-fetch manager has fallen behind the rate at which the pre-fetched IO data is executed by performing the following:
measure a number of IO requests that are received at the first memory that stores the IO data, wherein a large number of measured IO requests is indicative that the pre-fetch manager has fallen behind the rate at which the pre-fetched IO data is executed.

5. The computing system of claim 1, wherein the detector component is configured to determine that the pre-fetch manager has fallen behind the rate at which the pre-fetched IO data is executed by performing the following:
measure a total amount of time that the pre-fetch manager pre-fetches the IO data; and
compare the measured total amount of time with an expected amount of time that the pre-fetch manager should pre-fetch the IO data,
wherein it is indicative that the pre-fetch manager has fallen behind the rate at which the pre-fetched IO data is executed when the measured total amount of time exceeds the expected amount of time.

6. The computing system of claim 1, wherein the detector component is configured to determine that the pre-fetch manager has fallen behind the rate at which the pre-fetched IO data is executed by performing the following:
measure the size of the IO data that is pre-fetched by the pre-fetch manager; and
compare the measured size with an expected size,
wherein it is indicative that the pre-fetch manager has fallen behind the rate at which the pre-fetched IO data is executed when the measured size is less than the expected size.

7. The computing system of claim 1, wherein the optimizer component is configured to cause the pre-fetch manager to pre-fetch the subset of the IO data during the pause window in disk offset order.

8. The computing system of claim 1, wherein the magnitude of the subset of IO data pre-fetched during the pause window is adaptively determined by the optimizer component over the course of a plurality of subsequent boot processes.

9. The computing system of claim 1, wherein the magnitude of the subset of IO data pre-fetched during the pause window is determined by the optimizer component in real time.

10. The computing system of claim 1, wherein there are a plurality of pause windows during which the pre-fetch manager may pre-fetch the determined magnitude of IO data.

11. In a computing system that includes a pre-fetch manager that is configured to pre-fetch Input/Output (IO) data upon initiation of a boot process, the computing system configured to execute the pre-fetched IO data during the boot process, a method for adaptively improving the efficiency of the boot process to thereby increase the likelihood that the pre-fetch manager will pre-fetch the IO data at or close to a rate at which the computing system is able to execute the pre-fetched IO data, the method comprising:
an act of determining that an amount of IO data pre-fetched by the pre-fetch manager has fallen behind a rate at which the pre-fetched IO data is executed by the computing system;
an act of pausing the boot process to create a pause window;
an act of causing the pre-fetch manager to pre-fetch during the pause window a subset of the IO data, the subset having a magnitude that is determined to be likely to result in the amount of IO data pre-fetched by the pre-fetch manger to substantially match the rate at which the computing system is able to execute the pre-fetched IO data when the pause window is ended; and
an act of ending the pause window and allowing the boot process to resume.

12. The method of claim 11, wherein the act of determining that an amount of IO data pre-fetched by the pre-fetch manager has fallen behind comprises:
an act of measuring a pend IO count; and
an act of comparing the measured pend IO count with a threshold, wherein when the measured pend count is higher than the threshold it is indicative that the pre-fetch manager has fallen behind the rate at which the pre-fetched IO data is executed.

13. The method of claim 11, wherein the act of determining that an amount of IO data pre-fetched by the pre-fetch manager has fallen behind comprises:
an act of measuring a number of IO requests that are received at a memory that stores the IO data, wherein a large number of measured IO requests is indicative that the pre-fetch manager has fallen behind the rate at which the pre-fetched IO data is executed.

14. The method of claim 11, wherein the act of determining that an amount of IO data pre-fetched by the pre-fetch manager has fallen behind comprises:
an act of measuring a total amount of time that the pre-fetch manager pre-fetches the IO data; and
an act of comparing the measured total amount of time with an expected amount of time that the pre-fetch manager should pre-fetch the IO data,
wherein it is indicative that the pre-fetch manager has fallen behind the rate at which the pre-fetched IO data is executed when the measured total amount of time exceeds the expected amount of time.

15. The method of claim 11, wherein the act of determining that an amount of IO data pre-fetched by the pre-fetch manager has fallen behind comprises:
an act of measuring the size of the IO data that is pre-fetched by the pre-fetch manager; and
an act of comparing the measured size with an expected size,
wherein it is indicative that the pre-fetch manager has fallen behind the rate at which the pre-fetched IO data is executed when the measured size is less than the expected size.

16. The method of claim 11, further comprising:
an act of measuring the pre-fetched IO data at one or more boot markers of the boot process;
an act of assigning a weight to the pre-fetched IO measured at each boot marker; and
an act of determining at least one of the magnitude of the subset of IO data pre-fetched during the pause window or a size of the paused window based on the assigned weights.

17. The method of claim 11, wherein the act of causing the pre-fetch manager to pre-fetch during the pause window a subset of the predetermined IO data comprises:
an act of pre-fetching the IO data in disk offset order.

18. The method of claim 1, wherein the magnitude of the subset of IO data pre-fetched during the pause window is adaptively determined over the course of a plurality of subsequent boot processes or in real time.

19. The method of claim 11, wherein there are a plurality of pause windows during which the pre-fetch manager may pre-fetch the determined magnitude of IO data.

20. A computer program product comprising one or more computer-readable storage media having thereon computer-executable instructions that are structured such that, when executed by one or more processors of an underlying computing system, adapt the computing system to performing the following:
determine that an amount of Input/Output (IO) data pre-fetched by the pre-fetch manager has fallen behind a rate at which the pre-fetched IO data is executed by the computing system;
pause the boot process to create a pause window;
cause the pre-fetch manager to pre-fetch during the pause window a subset of the IO data, the subset having a magnitude that is determined to be likely to result in the amount of IO data pre-fetched by the pre-fetch manger to substantially match the rate at which the computing system is able to execute the pre-fetched IO data when the pause window is ended; and
end the pause window and allow the boot process to resume.
